(19) United States
(12) Patent Application Publication
(10) Pub. No.: US 2006/0226779 A1
(43) Pub. Date: Oct. 12, 2006

(54) Plasma display panel

(76) Inventor: Jung-Keun Ahn, Chunan-si (KR)

Correspondence Address: LEE & MORSE, P.C., 3141 FARIVIEW PARK DRIVE, SUITE 500, FALLS CHURCH, VA, 22042, US

(21) Appl. No.: 11/398,716

(22) Filed: Apr. 6, 2006

(30) Foreign Application Priority Data
Apr. 6, 2005 (KR) 10-2005-0028521

(51) Int. Cl. H01J 17/49

(52) U.S. Cl. 313/583; 313/582

(57) ABSTRACT

A plasma display panel (PDP) includes a first substrate and a second substrate disposed opposite to each other and having a plurality of discharge cells therebetween, and display electrodes disposed in parallel and extending in a predetermined direction on the first substrate, wherein each of the display electrodes respectively includes a plurality of line portions spaced apart from each other, and an extension portion connected to each line portion of the plurality of line portions and extending in the predetermined direction, wherein a first width of the extension portion at a boundary between the extension portion and the plurality of line portions is about equal to a distance between outer edges of outermost line portions the plurality of line portions.

### BACKGROUND OF THE INVENTION

1. Field of the Invention

The present invention relates to a plasma display panel. More particularly, the present invention relates to a plasma display panel having an electrode structure that provides enhanced display brightness, reduced electrode resistance and robust manufacturing characteristics.

2. Description of the Related Art

In general, a plasma display panel (PDP) is a display device that produces an image using visible light that is generated by exciting a phosphor layer with vacuum ultraviolet (VUV) light, where the VUV light is emitted by a plasma during gas discharge. PDPs are particularly suitable for use as commercial flat panel displays and television or video displays. PDPs offer a number of desirable characteristics, such as wide screens, e.g., 60 inches or more, and reduced thickness, e.g., less than 10 cm. Additionally, PDPs exhibit excellent color reproduction and wide viewing angles, since, like cathode ray tubes (CRTs), PDPs are self-emissive display elements. Additionally, PDPs allow for enhanced manufacturing productivity and reduced production costs, since the fabrication method therefore is relatively simple, particularly as compared to that of liquid crystal displays (LCDs).

A common PDP structure employs a three-electrode surface-discharge. The typical three-electrode surface-discharge PDP includes a front substrate and a rear substrate with a space therebetween, display electrodes disposed on the front substrate, and address electrodes disposed on the rear substrate and crossing the display electrodes in positions corresponding to discharge cells. The front and rear substrates are combined and sealed, and a discharge gas is filled into the space therebetween. Typically, an address discharge is generated in a discharge cell by a voltage signal applied between a display electrode, e.g., a scan electrode, corresponding to a display line and being individually controlled, and an address electrode. A sustain discharge is typically generated by a voltage signal applied between display electrodes, e.g., between the scan electrode and a sustain electrode, which may be located on the same surface of the front substrate and may face each other with a gap therebetween. In this form, the address discharge determines whether a discharge will occur, and brightness is determined by the sustain discharge.

Where the display electrodes, e.g., the scan and sustain electrodes, are disposed on the front substrate, i.e., the substrate closest to the viewer, the display electrodes may be formed of a transparent material so as not to block the visible light emitted from the discharge cells. However, since electrodes formed of transparent materials may have a relatively high resistance, highly conductive metal electrodes may also be provided, in combination with the transparent electrodes, in order to compensate for the relatively poor electrical conductivity of the transparent electrodes. Since the metal electrodes block visible light, they are typically formed on the sides of the transparent electrodes, in order to reduce the impact of the metal electrodes on the display brightness.

Poor conductivity of transparent electrodes may result in a decreased firing voltage at the discharge cells. Additionally, the transparent electrode material, e.g., ITO (Indium Tin Oxide), may be very expensive, which may increase the unit price of the PDP and hinder price competitiveness for the manufacturer. Further, forming the sustain electrodes and the scan electrodes to have both transparent electrodes and metal electrodes may increase the complexity of the manufacturing processes, further hindering price competitiveness and reducing productivity.

The information disclosed above in this Background of the Invention section is only provided to aid in understanding the aspects of the present invention described in detail below.

### SUMMARY OF THE INVENTION

The present invention is therefore directed to a PDP which substantially overcomes one or more of the problems due to the limitations and disadvantages of the related art.

It is therefore a feature of an embodiment of the present invention to provide a PDP using metal electrodes to provide a PDP exhibiting luminous brightness and a stable discharge.

It is therefore another feature of an embodiment of the present invention to provide a PDP in which connecting structures between display electrodes and terminal portions thereof are configured to reduce separation of the display electrodes from the substrate during manufacturing.

The above and other features and advantages of the present invention may be realized by providing a plasma display panel (PDP) including a first substrate and a second substrate disposed opposite to each other and having a plurality of discharge cells therebetween, and display electrodes disposed in parallel and extending in a predetermined direction on the first substrate, wherein each of the display electrodes respectively includes a plurality of line portions spaced apart from each other, and an extension portion connected to each line portion of the plurality of line portions and extending in the predetermined direction, wherein a first width of the extension portion at a boundary between the extension portion and the plurality of line portions is about equal to a distance between outer edges of outermost line portions the plurality of line portions.

The extension portion may narrow in the predetermined direction. Each of the display electrodes may respectively further include a terminal portion connected to the extension portion, the terminal portion having a second width. The extension portion may be disposed between the plurality of line portions and the terminal portion, and the extension portion may narrow from the first width to the second width. The PDP may include at least two first display electrodes having terminal portions disposed on a first side of the PDP and at least one second display electrode having a terminal portion disposed on a second side of the PDP, the second side being opposite to the first side, and wherein the terminal portions of the at least two first display electrodes may be gathered together, such that a distance between outermost edges of the terminal portions is less than a distance between outermost edges of the corresponding line portions. Each of the at least two first display electrodes and the at least one second display electrode may be disposed on a same surface of the first substrate.

The line portions may be opaque. The line portions may be metal. The display electrodes may be disposed on the first substrate and may not include transparent portions.

The above and other features and advantages of the present invention may also be realized by providing a plasma display panel including a front substrate having first and second display electrodes, a rear substrate having address electrodes, and a plurality of barrier ribs disposed between the front and rear substrates and defining at least one discharge cell, wherein the discharge cell is crossed by a first display electrode, a second display electrode and an address electrode, the first and second display electrodes each having at least two electrode portions separated by a space, the front substrate has an exposed region projecting beyond an edge of the rear substrate, the first display electrode has a first terminal portion disposed in the exposed region, and the first display electrode has a tapered extension region, the tapered extension region having edges aligned with outer edges of the at least two electrode portions of the first display electrode and aligned with outer edges of the first terminal portion.

The first terminal portion may have a constant width in the exposed region. Each of the first and second display electrodes may include a first electrode portion extending in a predetermined direction and a second electrode portion extending parallel to the first electrode portion and spaced apart from the first electrode portion, the respective second electrode portions may be disposed facing each other across a center of the discharge cell, and the respective second electrode portions may be disposed between the respective first electrode portions. Recesses may be formed in the second electrode portions at the center of the discharge cell. The edges of the tapered extension region may be straight, and a distance between the edges of the tapered extension region may decrease monotonically towards the first terminal portion.

The PDP may further include a third display electrode, wherein the first display electrode may have a first electrode portion extending in the predetermined direction and a second electrode portion extending parallel to the first electrode portion and spaced apart from the first electrode portion, the third display electrode may have a first electrode portion extending in the predetermined direction and a second electrode portion extending parallel to the first electrode portion of the third display electrode, disposed closer to a center of a discharge cell than is the first electrode portion of the third display electrode and spaced apart from the first electrode portion of the third display electrode, the third display electrode may have a second terminal portion disposed adjacent to the first terminal portion in the exposed region, and the second electrode portion of the first display electrode and the first electrode portion of the third display electrode may be disposed between the first electrode portion of the first display electrode and the second electrode portion of the third display electrode.

The first electrode portion of the first display electrode may have an inner edge and an outer edge, the inner edge being closer to the third display electrode than is the outer edge, and an included angle defined between the outer edge of the first electrode portion of the first display electrode and an outer edge of the corresponding tapered extension region may be greater than 90°.

The first and second display electrodes may each have three electrode portions extending in parallel, and the first and second display electrodes each have a plurality of connecting portions, each connecting portion intersecting the three electrode portions and connecting the three electrode portions with one another.

The above and other features and advantages of the present invention may further be realized by providing a plasma display module, including a housing having an opening constituting a viewing window, a plurality of integrated circuits, and a plasma display panel disposed in the housing, wherein the plasma display panel includes a front substrate disposed adjacent to the opening, a rear substrate disposed adjacent to the front substrate, a row of discharge cells defined by barrier ribs between the front and rear substrates, and a scan electrode and sustain electrode pair coupled to the plurality of integrated circuits, the scan electrode and sustain electrode pair corresponding to the row of discharge cells, each of the scan electrode and sustain electrode having at least two electrode line portions, such that the row of discharge cells has at least four electrode line portions, wherein the at least two electrode line portions of the scan electrode are coupled to an extension portion that tapers from a width of the scan electrode to a width of a terminal portion of the scan electrode.

A first end of a flexible connector may be attached to the terminal portion and a second end of the flexible connector is coupled to a scan circuit of the plurality of integrated circuits. The sustain electrode may be coupled to a sustain circuit of the plurality of integrated circuits, the scan electrode may be connected to a scan circuit of the plurality of integrated circuits, and the sustain circuit and the scan circuit may be configured to apply a sustain voltage across the sustain and scan electrodes.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a schematic plan view of a PDP according to an embodiment of the present invention;

FIG. 2 illustrates an arrangement and relationship of display electrodes and barrier ribs in discharge cells of the PDP of FIG. 1;

FIG. 3 illustrates an enlarged view of extension portions extending between line portions and terminal portions of display electrodes of the PDP of FIG. 1;

FIG. 4 illustrates another view of an extension portion of FIG. 3; and

FIG. 5 illustrates a plasma display module according to an embodiment of the present invention.

### DETAILED DESCRIPTION OF THE INVENTION

Korean Patent Application No. 10-2005-0028521, filed on Apr. 6, 2005, in the Korean Intellectual Property Office and entitled: “Plasma Display Panel,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. It will also be understood that when a layer is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

A PDP according to the present invention may include a plurality of display electrodes, which may each have a plurality of line portions. The display electrodes may be made of a conductive material, e.g., a metal. Due to the arrangement of the line portions, the conductive material may be opaque. Extension portions of the display electrodes may connect and transition between the line portions and terminal portions of the display electrodes.

As a PDP according to the present invention may include display electrodes configured with pluralities of line portions made of metal, the resistance of the display electrodes may be reduced, and thereby the discharge firing voltage may be reduced. In addition, since the display electrodes may include pluralities of line portions, the aspect ratio and luminous brightness of the PDP may be maintained even in the case that the display electrodes are opaque, e.g., metal.

The line portions may have exposed edges. Typically, curling, wherein a part of the electrode curls upward, can occur during a firing process, particularly at ends of the line portions. However, according to one aspect of the present invention, curling of the line portions of the display electrodes during firing may be reduced or prevented by combining the ends of the line portions of the electrode together, by making the widths of the extension portions equal to the widths between the outer edges of the respective first line portions and the second line portions of the corresponding electrode, and by making the widths of the extension portions gradually decrease. In the meantime, the thickness of a dielectric layer covering the line portions is reduced at the location where curling occurs. Thus, breakdown of the dielectric layer at the location where curling occurs can be generated during a discharge. However, according to one aspect of the present invention, breakdown of the dielectric layer may be reduced or prevented because curling of the line portions of the display electrodes can be prevented. Further, since the line portions may be connected to the terminal portions via the extension portions, a contact area between the line portions and the front substrate may be increased.

In particular, the extension portions of individual display electrodes may be configured such that, for a given display electrode, the individual line portions come together to form a single terminal portion. This may increase the contact area between the display electrode and the front substrate. This configuration may also reduce the number of edges of the display electrode, i.e., by eliminating internal edges of the line portions in the extension portion. This may reduce or eliminate separation and/or curling of the edges of the line portions, which may otherwise occur, for example, during a manufacturing firing process.

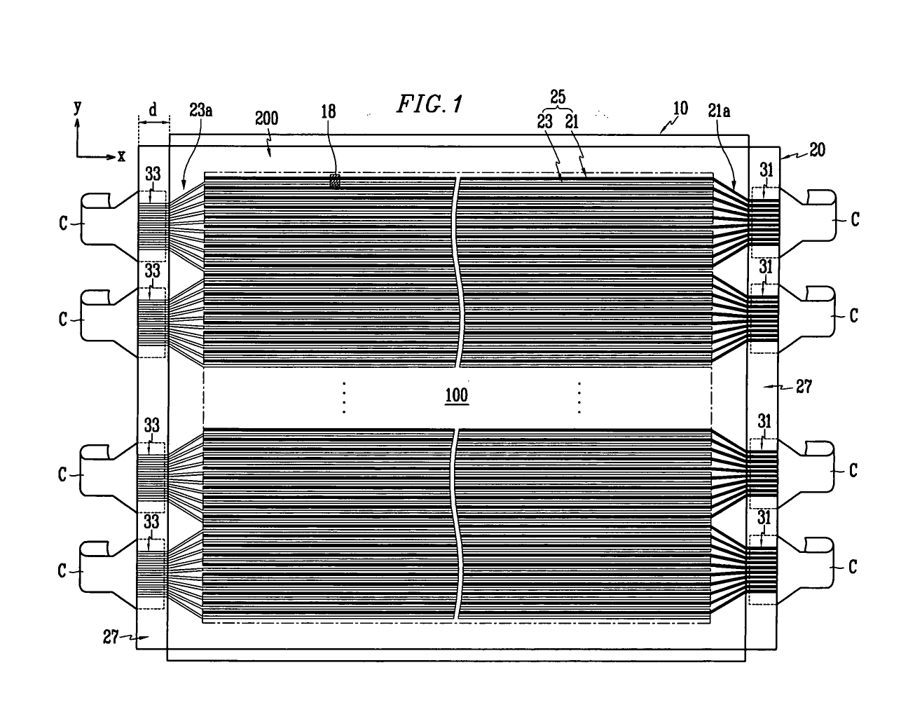

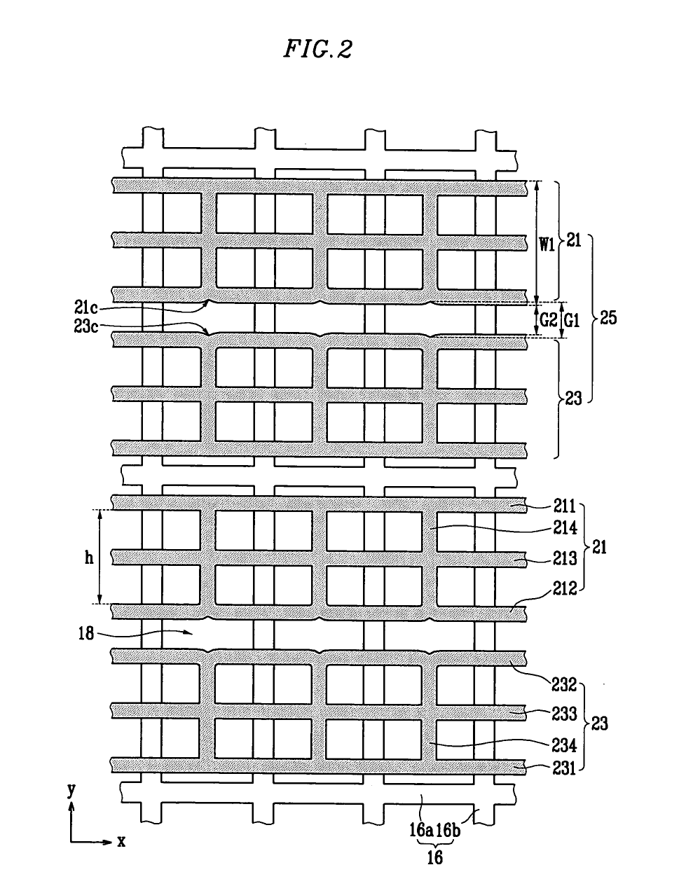

FIG. 1 illustrates a schematic plan view of a PDP according to an embodiment of the present invention. Referring to FIG. 1, a PDP according to an embodiment of the present invention may include a front substrate 20 and a rear substrate 10 disposed opposite to each other with a predetermined gap therebetween. A plurality of discharge cells 18 for generating plasma discharge may be defined by barrier ribs 16 (shown in FIG. 2) between the front substrate 20 and the rear substrate 10. Phosphor layers (not shown) for emitting visible light may be formed inside the discharge cells 18.

Address electrodes (not shown) may be formed between the front substrate 20 and the rear substrate 10, and may extend in a first direction, e.g., the y-axis direction. Display electrodes 25 may be formed to extend in a second direction, e.g., the x-axis direction, crossing the first direction. The positions of the discharge cells 18 may correspond to the locations where the address electrodes and the display electrodes 25 cross each other.

The PDP may include a display area 100, for displaying a visible image, and a non-display area 200, which does not display the image.

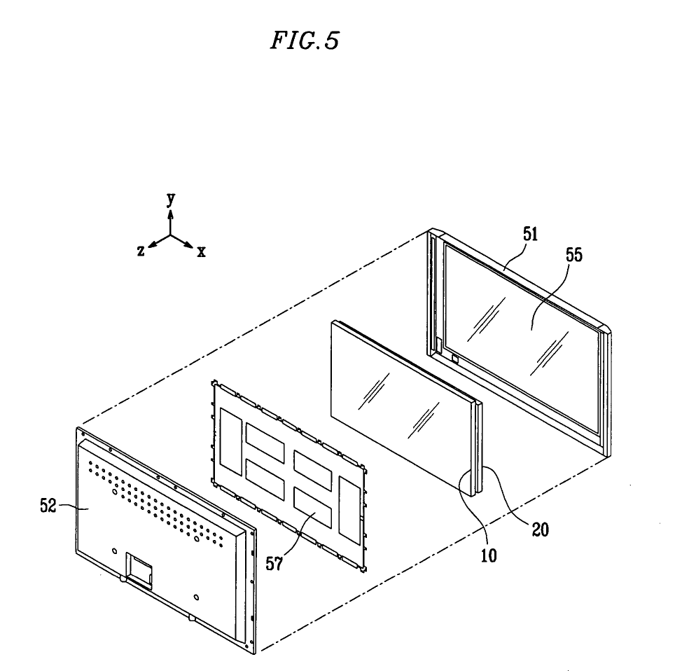

Referring to FIG. 5, the PDP may be assembled into a housing to form a plasma display module. The housing may include an opening or window 55 in a front portion 51 thereof, through which the display area 100 is visible, so that a user of the plasma display module may view the displayed image.

The housing may also contain a plurality of integrated circuits 57 coupled to the plasma display panel by connecting lines C (see FIG. 1) for driving the display electrodes 25. The discharge cells 18 may be formed in the display area 100 of the PDP, and the non-display area 200 may be allocated for tolerance in manufacturing procedures. The housing may include a rear portion 52 to enclose the rear of the PDP.

The display electrodes 25 may include scan electrodes 21 and sustain electrodes 23. The scan electrodes 21 and the sustain electrodes 23 may be paired at each discharge cell 18 and may be disposed so as to oppose each other at each discharge cell 18. The center of the discharge cell 18 may lie between the scan electrodes 21 and the sustain electrodes 23. During operation of the PDP, a difference in voltages between a given scan electrode 21 and a given address electrode may induce a discharge in a given discharge cell 18, i.e., the scan electrode 21 and the address electrode may select the particular discharge cell 18 that is to be turned on. A difference in voltages between a sustain electrode 23 and a corresponding scan electrode 21 may sustain the discharge in the selected discharge cell 18.

The front substrate 20 may be suitably sized and positioned with respect to the rear substrate 10 such that, when it is attached to the rear substrate 10, a predetermined overhang with dimension d exists at each side in the second direction. That is, with reference to FIG. 1, the left-hand edge of the front substrate 20 may extend beyond the left-hand edge of the rear substrate 10 by the distance d and the right-hand edge of the front substrate 20 may extend beyond the right-hand edge of the rear substrate 10 by the distance d, such that portions the front substrate 10 and the rear substrate 20 do not overlap. The overhang may provide exposed areas 27 adjacent to the left and right edges of the front substrate 20. That is, the exposed areas 27 may be located along the left and right sides of the non-display area 200. The exposed areas 27 may expose the inner surface of the front substrate 20, i.e., the surface closest to the rear substrate 10, to the outside, as the exposed areas 27 of the front substrate 20 are not overlapped by the rear substrate 10.

The scan electrodes 21 and the sustain electrodes 23 may extend beyond the display area 100 in the second direction, i.e., to one or both sides of the PDP, to end with terminal portions 31 and 33, respectively, disposed in the non-display area 200. The terminal portions 31 and 33 of the scan and sustain electrodes 21 and 23, respectively, may be connected to one or more driving units, e.g., integrated circuits 57, which may provide voltage signals to the scan electrodes 21 and the sustain electrodes 23. As the exposed areas 27 not overlapped by the opposing substrate, the terminal portions 31 are also not overlapped by the opposing substrate, and the connecting lines C may be connected to the exposed terminal portions 31 and 33. The display electrodes 25 may be electrically connected to the driving unit(s) via the connecting lines C. The connecting lines C may be, e.g., flexible printed circuits (FPCs) or tape carrier packages (TCPs). Thus, voltage signals may be applied to pairs of display electrodes 25 corresponding to discharge cells 18 in order to control the plasma discharge in the discharge cells 18.

As illustrated in FIG. 1, the terminal portions 31 of the scan electrodes 21 are shown as extending in the second direction beyond the display area 100 on the right-hand side of FIG. 1, and the terminal portions 33 of the sustain electrodes 23 are shown as extending in the second direction beyond the display area 100 on the left-hand side of FIG. 1. The scan electrodes 21 and the sustain electrodes 23 may extend towards opposite exposed areas 27 without interfering with each other, and the terminal portions 31 and 33 may be disposed in the exposed areas 27. The scan electrodes 21 and the sustain electrodes 23, including the respective terminal portions 31 and 33, may compose electrode groups in the respective exposed areas 27.

The terminal portions 31 may be gathered together. That is, e.g., a distance between terminal portions 31 of each of the scan electrodes 21 may be less than a distance between the scan electrodes 21 in the display area 100. Similarly, the terminal portions 33 may be gathered together, such that a distance between the terminal portions 33 of each of the sustain electrodes 23 is less than a distance between the sustain electrodes 23 in the display area 100.

FIG. 2 illustrates an arrangement and relationship of display electrodes 25 and barrier ribs 16 in discharge cells of the PDP of FIG. 1. Referring to FIG. 2, sides of the discharge cells 18 may be defined by barrier ribs 16. Transverse barrier rib portions 16a may extend in the second direction, e.g., the x-axis direction, and longitudinal barrier rib portions 16b may extend in the first direction, e.g., the y-axis direction, to intersect the transverse barrier rib portions 16a. The barrier ribs 16 may define a lattice of discharge cells 18. Other configurations of barrier ribs 16 may also be implemented, including configurations in which more than two barrier rib portions are used to define discharge cells.

A pair of the display electrodes 25 may correspond to each of the discharge cells 18. Each of the scan electrodes 21 and the sustain electrodes 23 may include a plurality of line portions that are spaced from one another by a predetermined distance. That is, e.g., the scan electrodes 21 may each include a plurality of line portions 211, 212 and 213, each extending in the second direction, e.g., the x-axis direction. Similarly, the sustain electrodes 23 may each include a plurality of line portions 231, 232 and 233. The line portions, i.e., 211, 212 and 213 of the scan electrodes 21 and 231, 232 and 233 of the sustain electrodes 23, may be made of a material having good electrical conductivity, e.g., a metal such as chromium (Cr) or silver (Ag). The line portions may be opaque.

The scan electrodes 21 and the sustain electrodes 23 may be symmetrically formed about the centers of the respective discharge cells 18.

Further details of the scan electrodes 21 will now be provided, and, as the sustain electrodes 23 may be similar, these details will not be repeated for the sustain electrodes 23 in order to avoid repetition.

For each scan electrode 21, the first line portion 211 may be disposed nearest to the transverse barrier rib portions 16a and may extend parallel to the transverse barrier rib portions 16a in the same direction as the transverse barrier rib portions 16a, e.g., the x-axis direction. The second line portion 212 may be disposed toward the center of the discharge cells 18 and may extend parallel to the first line portion 211.

The first and second line portions 211 and 212 may be formed of, e.g., thin films, and may be arranged in stripes having a predetermined width. Vacant spaces may remain around and between the first line portion 211 and the second line portion 212. Therefore, visible light may be emitted from the discharge cells 18 even if the line portions 211 and 212 are opaque. Thus, the configuration of the display electrodes 25 helps maintain the luminous brightness of the PDP.

Each sustain electrode 23 may include the first line portion 231 and the second line portion 232. The second line portion 232 of the sustain electrode 23 may be disposed opposite to the second line portion 212 of the corresponding scan electrode 21, with the centers of the discharge cells 18 therebetween, thereby forming discharge gaps. A discharge may be generated between the respective second line portions 212 and 232 of the scan electrodes 21 and the sustain electrodes 23 during an initial discharge stage.

After the initial discharge stage, the discharge may diffuse to the respective first line portions 211 and 231 of the scan electrodes 21 and the sustain electrodes 23. As the respective first line portions 211 and 231 may be disposed adjacent to opposite sides of the discharges cells 18, a surface discharge using substantially the entire areas of the discharge cells 18 may be achieved.

The first and second line portions 211 and 212 of the scan electrodes 21, as well as the first and second line portions 231 and 232 of the sustain electrodes 23, may be separated by a distance h. That is, a discharge gap between the first and second line portions 211 and 212 of the scan electrode 21 may be h. If the distance h is too great, e.g., greater than about 130 μm, it may be difficult to diffuse the plasma discharge across the gap. This may reduce the discharge efficiency of the discharge cells 18.

As noted above, each scan electrode 21 may include the third line portion 213, which may be disposed between the first line portion 211 and the second line portion 212. The third line portion 213 may effectively reduce the discharge gap h between the first line portion 211 and the second line portion 212 and may help diffuse the plasma discharge across the area of the discharge cells 18. Thus, in the case that the arrangement and relationship of the display electrodes 25 and the barrier ribs 16 in the discharge cells 18 is such that the inclusion of third line portion 213 would prove beneficial to the discharge efficiency of the discharge cells 18, the third line portions 213 may be added. The third line portion 213 may be formed in the same shape as the first line portion 211 and the second line portion 212, and may be oriented in the same way as the first line portion 211 and the second line portion 212, e.g., disposed in parallel with the transverse barrier rib portions 16a. Similarly, respective third line portions 233 of the sustain electrodes 23 may be provided between the first line portions 231 and the second line portions 232 thereof.

Each scan electrode 21 may include connecting portions 214, which may be provided between the first line portion 211 and the second line portion 212. The connecting portions 214 may intersect the first line portion 211, the second line portion 212 and the third line portion 213, so as to electrically connect the same. Multiple connecting portions 214 may be provided per discharge cell 18 (not shown). The connecting portions 214 may be oriented in parallel with the longitudinal barrier rib portions 16b. The connecting portions 214 may be oriented at an angle with respect to the first, second and third line portions 211, 212 and 213, and may extend between only the first and third line portions 211 and 213, or between only the second and third line portions 212 and 213 (not shown). Connecting portions 234 may be similarly provided for the sustain electrodes 23.

As described above, when the scan electrodes 21 are provided with the third line portions 213, the connecting portions 214 may be oriented in parallel with the longitudinal barrier ribs 16b and may extend to connect the first line portions 211, the second line portions 212 and the third line portions 213 with one another. Since the first line portions 211 may be connected to the second line portions 212 via the connecting portions 214, wall charges generated during the plasma discharge process may be moved along the connecting portions 214. Thus, a discharge generated between the respective second line portions 212 and 232 of the scan electrodes 21 and the sustain electrodes 23 may be easily diffused to the respective first line portions 211 and 231.

The second line portions 212 of the scan electrodes 21 may be provided with recesses 21c for each respective discharge cell 18. The recesses 21c may be located in the second line portions 212 at positions that are substantially centered in the respective discharge cells 18. The recesses 21 c may serve to increase a discharge gap between the respective second line portions 212 and 232 of the scan electrodes 21 and the sustain electrodes 23. Respective recesses 23c may be provided in the second line portions 232 of the sustain electrodes 23. The recesses 21c and 23c may be aligned to face each other within each respective discharge cell 18.

Referring to FIG. 2, the facing edges of the respective second line portions 212 and 232 of the scan electrodes 21 and the sustain electrodes 23 may be spaced apart and separated by a relatively short discharge gap G2 along a substantial fraction of the facing edges. However, where the respective recesses 21c and 23c are located, e.g., in the center of the discharge cells 18, a relatively a long discharge gap GI may be created. Thus, the discharge gap between the respective second line portions 212 and 232 may include the relatively short gap G2 and the relatively long gap G1.

A plasma discharge in a given discharge cell 18 may diffuse from the short discharge gap G2 into the long discharge gap GI, so that the plasma discharge is diffused into substantially all of and/or the entire discharge cell 18, while the short discharge gap G2 may allow for a lower discharge firing voltage, thereby enhancing discharge efficiency. In addition, the plasma discharge may be concentrated at the centers of the discharge cells 18 by the recesses 21c and 23c, thereby stabilizing the discharge.

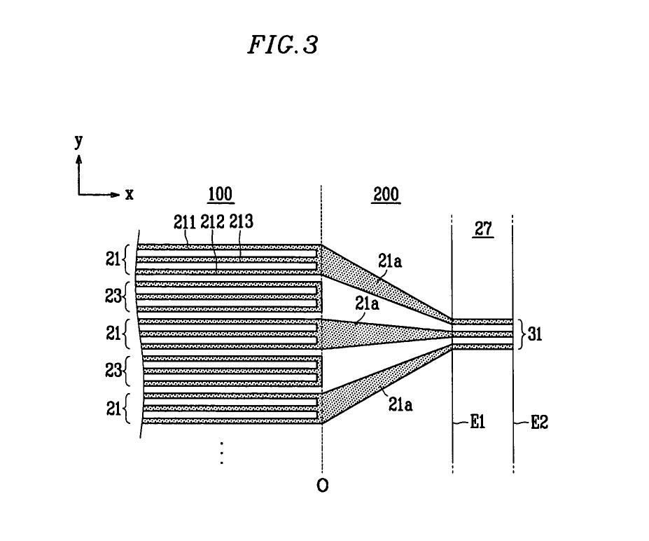

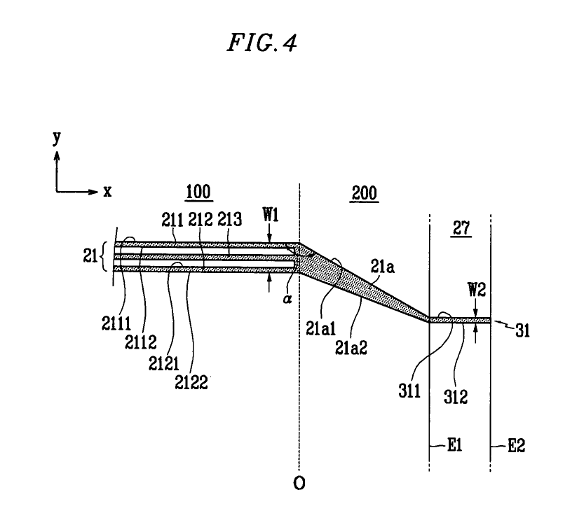

FIG. 3 illustrates an enlarged view of extension portions extending between line portions and terminal portions of display electrodes of the PDP of FIG. 1, and FIG. 4 illustrates another view of the extension portion of FIG. 3. Details of the display electrodes 25 are also illustrated in FIG. 2, as noted above. Referring to FIGS. 2, 3 and 4, the scan electrodes 21 may be disposed in the display area 100 and may include the plurality of individual line portions extending in the second direction, e.g., first line portions 211, second line portions 212 and third line portions 213 extending in the x-axis direction. The line portions 211, 212 and 213 may extend to a predetermined point, e.g., the individual line portions 211, 212 and 213 may end substantially at the edge of the display area 100, which is indicated by the reference line 0 in FIG. 3. The individual line portions 211, 212 and 213 may join together, e.g., into a single line, at respective regions located along the reference line 0.

The display electrodes 25 may each include an extension portion 21a, 23a that forms a transition between the line portions 211, 212, 213, 231, 232 and 233 of the respective display electrode 25 and the terminal portion 21a, 23a thereof. In detail, each scan electrode 21 may include an extension portion 21a that extends generally in the second direction, e.g., generally in the x-axis direction, between the line portions 211, 212 and 213 of the scan electrode 21, which correspond to the display region 100, and the terminal portion 31 of the scan electrode 21. The extension portion 21a may extend from the line portions 211, 212 and 213 at an angle, such that the terminal portions 31 of multiple scan electrodes 21 may be gathered together. The angle may be greater than 90°. For example, referring to FIG. 4, an angle α defined between an outer edge 21a1 of the extension region 21a and an outer edge 2111 of the first line portion 211 may be greater than 90°.

The extension portion 21a may be disposed substantially in the non-display area 200, between the display area 100 and the exposed area 27. That is, the extension portion 21a may extend roughly between the reference line 0 and an edge of the rear substrate 10, which is indicated in FIG. 3 by the end line El. The terminal portions 31 that extend from the extension portions 21a may be disposed in the exposed area 27, between the edge of the rear substrate 10 and the edge of the front substrate 20, i.e., between the end line E1 of the rear substrate 10 and the end line E2 of the front substrate 20.

The width of the extension portion 21a may gradually decrease along the transition between the line portions 211, 212 and 213 of the scan electrode 21 and the terminal portion 31 thereof. That is, the width of the extension portion 21a may decrease along the second direction. The width of the extension portion 21a, as measured in the first direction, e.g., the y-axis direction, at the boundary between the ends of the individual line portions 211, 212 and 213 and the extension portion 21a, may be about equal to a distance w1 between outer edges of the outermost line portions 211 and 212.

That is, the width of the extension portion 21a, as measured in the y-axis direction at reference line 0, may be about equal to the distance w1 between the outer edge 2111 of the first line portion 211 and an outer edge 2122 of the second line portion 212. Thus, outer edges 21a1 and 21a2 of the extension portion 21a may coincide with the outer edge 2111 of the first line portion 211 and the outer edge 2122 of the second line portion 212.

The end of the first line portion 211 and the end of the second line portion 212 may be combined in the extension portion 21a. In the case that the third line portion 213 is provided, the end thereof may likewise be combined with the ends of the first line portion 211 and the second line portion 212 in the extension portion 21a.

The scan electrodes 21 may have a predetermined width w2 at the end line El and may extend to the end line E2 of the front substrate 20 while maintaining the predetermined width w2. The width w2 may be equal to the width of the terminal portions 31, i.e., a distance between outer edges 311 and 312 of the terminal portion 31. Thus, the extension portions 21a may transition to the terminal portions 31, which may have a uniform width in the exposed area 27. The structure of the scan electrodes 21 may be repeated in the opposite direction for the sustain electrodes 23, i.e., the sustain electrodes 23 may have an offset mirror image structure, with the terminal portions 33 exposed on the left-hand exposed area 27 in FIG. 1.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A plasma display panel (PDP), comprising:
a first substrate and a second substrate disposed opposite to each other and having a plurality of discharge cells therebetween; and
display electrodes disposed in parallel and extending in a predetermined direction on the first substrate, wherein each of the display electrodes respectively includes:
a plurality of line portions spaced apart from each other, and an extension portion connected to each line portion of the plurality of line portions and extending in the predetermined direction, wherein a first width of the extension portion at a boundary between the extension portion and the plurality of line portions is about equal to a distance between outer edges of outermost line portions the plurality of line portions.

2. The PDP as claimed in claim 1, wherein the extension portion narrows in the predetermined direction.

3. The PDP as claimed in claim 2, wherein each of the display electrodes respectively further includes a terminal portion connected to the extension portion, the terminal portion having a second width.

4. The PDP as claimed in claim 3, wherein the extension portion is disposed between the plurality of line portions and the terminal portion, and the extension portion narrows from the first width to the second width.

5. The PDP as claimed in claim 3, wherein the PDP includes at least two first display electrodes having terminal portions disposed on a first side of the PDP and at least one second display electrode having a terminal portion disposed on a second side of the PDP, the second side being opposite to the first side, and
wherein the terminal portions of the at least two first display electrodes are gathered together, such that a distance between outermost edges of the terminal portions is less than a distance between outermost edges of the corresponding line portions.

6. The PDP as claimed in claim 5, wherein each of the at least two first display electrodes and the at least one second display electrode is disposed on a same surface of the first substrate.

7. The PDP as claimed in claim 1, wherein the line portions are opaque.

8. The PDP as claimed in claim 7, wherein the line portions are metal.

9. The PDP as claimed in claim 7, wherein the display electrodes are disposed on the first substrate and do not include transparent portions.

10. A plasma display panel, comprising:
a front substrate having first and second display electrodes;
a rear substrate having address electrodes; and
a plurality of barrier ribs disposed between the front and rear substrates and defining at least one discharge cell, wherein the discharge cell is crossed by a first display electrode, a second display electrode and an address electrode, the first and second display electrodes each having at least two electrode portions separated by a space,
the front substrate has an exposed region projecting beyond an edge of the rear substrate,
the first display electrode has a first terminal portion disposed in the exposed region, and the first display electrode has a tapered extension region, the tapered extension region having edges aligned with outer edges of the at least two electrode portions of the first display electrode and aligned with outer edges of the first terminal portion.

11. The PDP as claimed in claim 10, wherein the first terminal portion has a constant width in the exposed region.

12. The PDP as claimed in claim 10 wherein each of the first and second display electrodes includes a first electrode portion extending in a predetermined direction and a second electrode portion extending parallel to the first electrode portion and spaced apart from the first electrode portion,
the respective second electrode portions are disposed facing each other across a center of the discharge cell, and
the respective second electrode portions are disposed between the respective first electrode portions.

13. The PDP as claimed in claim 12, wherein recesses are formed in the second electrode portions at the center of the discharge cell.

14. The PDP as claimed in claim 10, wherein the edges of the tapered extension region are straight, and a distance between the edges of the tapered extension region decreases monotonically towards the first terminal portion.

15. The PDP as claimed in claim 10, further comprising a third display electrode, wherein:
the first display electrode has a first electrode portion extending in the predetermined direction and a second electrode portion extending parallel to the first electrode portion and spaced apart from the first electrode portion,
the third display electrode has a first electrode portion extending in the predetermined direction and a second electrode portion extending parallel to the first electrode portion of the third display electrode, disposed closer to a center of a discharge cell than is the first electrode portion of the third display electrode and spaced apart from the first electrode portion of the third display electrode,
the third display electrode has a second terminal portion disposed adjacent to the first terminal portion in the exposed region, and
the second electrode portion of the first display electrode and the first electrode portion of the third display electrode are disposed between the first electrode portion of the first display electrode and the second electrode portion of the third display electrode.

16. The PDP as claimed in claim 15, wherein the first electrode portion of the first display electrode has an inner edge and an outer edge, the inner edge being closer to the third display electrode than is the outer edge, and
an included angle defined between the outer edge of the first electrode portion of the first display electrode and an outer edge of the corresponding tapered extension region is greater than 90°.

17. The PDP as claimed in claim 10, wherein the first and second display electrodes each have three electrode portions extending in parallel, and
the first and second display electrodes each have a plurality of connecting portions, each connecting portion intersecting the three electrode portions and connecting the three electrode portions with one another.

18. A plasma display module, comprising:
a housing having an opening constituting a viewing window;
a plurality of integrated circuits; and
a plasma display panel disposed in the housing, wherein the plasma display panel includes:
a front substrate disposed adjacent to the opening;
a rear substrate disposed adjacent to the front substrate;
a row of discharge cells defined by barrier ribs between the front and rear substrates; and
a scan electrode and sustain electrode pair coupled to the plurality of integrated circuits, the scan electrode and sustain electrode pair corresponding to the row of discharge cells, each of the scan electrode and sustain electrode having at least two electrode line portions, such that the row of discharge cells has at least four electrode line portions, wherein the at least two electrode line portions of the scan electrode are coupled to an extension portion that tapers from a width of the scan electrode to a width of a terminal portion of the scan electrode.

19. The plasma display module as claimed in claim 18, wherein a first end of a flexible connector is attached to the terminal portion and a second end of the flexible connector is coupled to a scan circuit of the plurality of integrated circuits.

20. The plasma display module as claimed in claim 18, wherein the sustain electrode is coupled to a sustain circuit of the plurality of integrated circuits,
the scan electrode is connected to a scan circuit of the plurality of integrated circuits, and
the sustain circuit and the scan circuit are configured to apply a sustain voltage across the sustain and scan electrodes.
